(19) United States
(12) Patent Application Publication
(10) Pub. No.: US 2011/0043952 A1
(43) Pub. Date: Feb. 24, 2011

(54) DEVICE FOR THE PREVENTION OF SERIOUS FAULTS IN ELECTRICAL MAINS SUPPLY NETWORKS

(76) Inventors: Werner Haussel, Feucht (DE); Michael Fett, Paderborn (DE); Martin Hofbeck, Nurnberg (DE)

Correspondence Address: Thomas R. Vigil Law Offices, 319 Bluff Court, Barrington, IL, 60010, US

(21) Appl. No.: 11/597,726

(22) PCT Filed: Feb. 25, 2005
(86) PCT No.: PCT/DE2005/000315

§ 371 Date: Aug. 25, 2008

(30) Foreign Application Priority Data
Mar. 8, 2004 (DE) 10 2004 011 551.6

(51) Int. Cl. H02H 9/00; H02H 1/00

(52) U.S. Cl. 361/52; 324/555

(57) ABSTRACT

The invention relates to a device for the prevention of serious faults in electrical mains supply networks by spectral analysis of the network voltage. The spectrum determined by a voltage A/D converter and a spectral analysis device is subjected to a classification by frequency intervals. The values for the frequency interval classes are correlated in the comparator with frequency interval class reference patterns for corresponding determined faults.

The present invention relates to a device for preventing serious faults in electrical mains supply networks having the features of the preamble of claim 1.

In recent years research has looked, increasingly, at the dynamics of electrical mains supply networks. Of particular interest is the analysis of non-linear systems permitting to assess the stability of electrical mains supply networks. In this context, the IEEE report “Voltage Stability Assessment Concepts, Practices and Tools, August 2002” summarizes some results and cites essential references.

The quintessence of these examinations and of further simulations and analyses of artificial mains networks is that certain excitations in an electric energy system generate dynamic compensation processes having characteristic properties. These have to be recognized if one wants to identify the exciting event. It has further been found that collapse phenomena, which may lead to serious faults, are always preceded by a series of dynamic events that can be identified beforehand. The particular influence of load dynamics onto the stability limits and the vibration dynamics was obtained through bifurcation analysis.

The fact that the collapse only occurs 15 s to 300 s after the identifiable dynamic events allows some leeway in preventing serious faults. During this time period, a subordinate drift process, a continuous voltage increase or drop occurs.

A device for detecting electrical arcs on power lines for providing advance warning of potentially dangerous conditions is known from WO 96/35250. A frequency analysis is carried out by means of filters with high-frequency broadband noise signals being indicative of an electrical arc.

By contrast, in accordance with the invention, the dynamic compensation processes preceding serious faults are considered through voltage spectral analysis. It is thereby of particular importance to divide the spectrum into a plurality of frequency interval classes. The frequency interval classes must be divided so that the various types of faults can be mapped by significant differences in the frequency interval classes.

By virtue of the simulations and analyses of artificial mains networks and of literature evaluation, the frequency interval classes for networks having a nominal frequency of 50 Hz are defined as follows:

| | Interval Class | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Frequency/ | ≧0.0 | ≧0.3 | ≧0.7 | ≧1.1 | ≧2.0 | ≧2.5 | ≧4.0 | ≧14.0 | ≧20.0 | ≧29.0 | ≧35.0 | ≧49.9 | ≧50.1 |
| Hz | <0.3 | <0.7 | <1.1 | <2.0 | <2.5 | <4.0 | <14.0 | <20.0 | <29.0 | <35.0 | <49.9 | <50.1 | |

For networks having a nominal frequency of 60 Hz, the frequency interval classes are defined as follows:

| | Interval Class | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Frequency/ | ≧0.0 | ≧0.3 | ≧0.7 | ≧1.1 | ≧2.0 | ≧2.5 | ≧4.0 | ≧14.0 | ≧20.0 | ≧29.0 | ≧35.0 | ≧59.9 | ≧60.1 |
| Hz | <0.3 | <0.7 | <1.1 | <2.0 | <2.5 | <4.0 | <14.0 | <20.0 | <29.0 | <35.0 | <59.9 | <60.1 | |

In particular cases, it is necessary to adaptively adjust the frequency interval classes to the load and vibration dynamics of the network. Online bifurcation analyses must be carried out for this purpose.

In accordance with the invention, the detection and analysis of faults relies on the fact that certain frequency interval class reference patterns, which belong to the various faults, occur. Here some examples of such patterns:

### Intermediate System Vibrations:

| | Interval Class | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Pattern | 1 | 1 | 0 | 0 | 0 | 0 | 0 | 0 | 0 | 0 | 0 | 0 | 0 |

### Localized Oscillations:

| | Interval Class | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Pattern | 0 | 0 | 1 | 1 | 1 | 0 | 0 | 0 | 0 | 0 | 0 | 0 | 0 |

### Torsional Vibration Mode 1

| | Interval Class | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Pattern | 0 | 0 | 0 | 0 | 0 | 0 | 0 | 1 | 0 | 0 | 0 | 0 | 0 |

### Torsional Vibration Supersynchronous Modes

| | Interval Class | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Pattern | 0 | 0 | 0 | 0 | 0 | 0 | 1 | 1 | 1 | 0 | 0 | 0 | 1 |

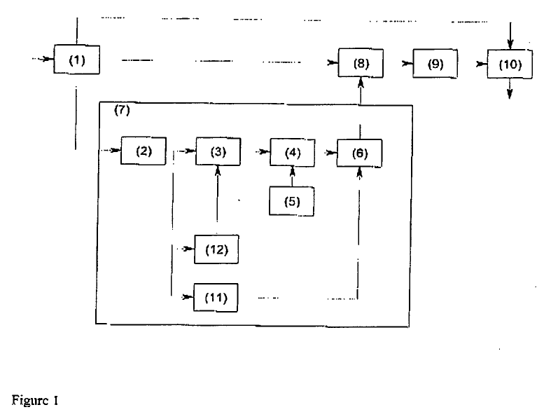

The device for the prevention of serious faults in electrical mains supply networks (7) (FIG. 1) consists of an A/D converter (2) that samples the voltage of the three-phase network (1) and makes the sampled values available to the spectral analysis device (3) and to the voltage measuring device (11). The spectral analysis device (3) computes the voltage values belonging to the discrete frequency intervals of the spectrum to be analyzed and transmits them to the comparator (4). The latter compares these interval values with the filed frequency patterns (5) mentioned above in connection with adjustable limit values for the interval values. If the comparison yields a fault the signal is transmitted to the evaluation device (6) in which the strategy for handling the fault has been defined. To adapt the frequency interval classes with respect to their frequency limit values, the sampled values are handed over to a bifurcation analyzer (12) which in turn transfers the new frequency limits to the spectral analysis device (3).

To assess the subordinate drift processes, the sampled values are supplied to the evaluation device (6) via the voltage measuring device (11). The specific nominal frequency of a network is also determined using the spectral analysis device (3).

There are several possibilities for the fault handling strategy. On the one side, messages can be delivered through visual display, relay outputs or communication interfaces. On the other side, corrective action can be taken on the voltage regulator (8) via the step switch (9) of the transformer (10). Upon detection of a potential serious fault, the regulator may either be shut down or adopt a set point at the lowest possible limit in order to counteract the impending collapse.

The device for the prevention of serious faults in electrical mains supply networks (7) and the regulator (8) may however also be integrated through corresponding communication interfaces in network management concepts for coordinated fault handling by shutting down the device (7) or by retrieving its information data and processing them in the master or SCADA system and by setting the regulator to a master mode with the set point being predetermined by the master or SCADA system.

We claim:

1. A device for preventing serious faults in electrical mains supply networks (7) by spectral analysis of the mains voltage
characterized in
that the spectrum determined by an AND voltage converter (2) and a spectral analysis device (3) is subjected to a classification into frequency intervals;
that the values of the frequency interval classes are correlated in a comparator (4) with the frequency interval class reference patterns associated with the determined faults;
and that, upon sensing a fault, an evaluation device (6) delivers a signal, one or a plurality of relay messages or one or a plurality of messages through communication interfaces.

2. The device for preventing serious faults in electrical mains supply networks as set forth in claim 1,
characterized in
that the frequencies are divided into the following 13 determined interval classes with frequency limit values:
(mains frequency 50 Hz)

| | Interval Class | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Frequency/ | ≧0.0 | ≧0.3 | ≧0.7 | ≧1.1 | ≧2.0 | ≧2.5 | ≧4.0 | ≧14.0 | ≧20.0 | ≧29.0 | ≧35.0 | ≧49.9 | ≧50.1 |
| Hz | <0.3 | <0.7 | <1.1 | <2.0 | <2.5 | <4.0 | <14.0 | <20.0 | <29.0 | <35.0 | <49.9 | <50.1 | |

or
(mains frequency 60 Hz)

| | Interval Class | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Frequency/ | ≧0.0 | ≧0.3 | ≧0.7 | ≧1.1 | ≧2.0 | ≧2.5 | ≧4.0 | ≧14.0 | ≧20.0 | ≧29.0 | ≧35.0 | ≧59.9 | ≧60.1 |
| Hz | <0.3 | <0.7 | <1.1 | <2.0 | <2.5 | <4.0 | <14.0 | <20.0 | <29.0 | <35.0 | <59.9 | <60.1 | |

3. The device for preventing serious faults in electrical mains supply networks as set forth in claim 1,
characterized in
that the frequency limit values and the number of frequency interval classes are adaptively adjusted to the local load and vibration dynamics of the network through the bifurcation analyzer (12).

4. The device for preventing serious faults in electrical mains supply networks as set forth in claim 1,
characterized in
that the comparator (4) is equipped with parametrizable limit values of the interval voltage for each frequency interval.

5. The device for preventing serious faults in electrical mains supply networks as set forth in claim 1,
characterized in
that the limit values of the interval voltage adjust automatically to the load conditions of the network.

6. The device for preventing serious faults in electrical mains supply networks as set forth in claim 1,
characterized in
that the evaluation device (6) delivers a visual signal upon sensing a fault.

7. The device for preventing serious faults in electrical mains supply networks as set forth in claim 1,
characterized in
that the evaluation device (6) delivers relay messages and/or messages through communication interfaces which influence a voltage regulator (8) insofar as the regulator shuts down or sets to another set point.

8. The device for preventing serious faults in electrical mains supply networks as set forth in claim 1,
characterized in
that the sampled values are supplied to the evaluation unit (6) via the voltage measuring device (11).

9. The device for preventing serious faults in electrical mains supply networks as set forth in any one of the claim 1,
characterized in
that, a fault having been sensed, the evaluation device (6) additionally monitors the long-run behaviour of the mains voltage in order to assess the fault.

10. The device for preventing serious faults in electrical mains supply networks as set forth in claim 9,
characterized in
that parameters for the gradient of the mains voltage are entered into the evaluation device (6).

11. The device for preventing serious faults in electrical mains supply networks as set forth in claim 1,
characterized in
that superordinate master and SCADA systems are capable of shutting down the device through communication interfaces.
